(19) United States
(12) Patent Application Publication
(10) Pub. No.: US 2004/0153503 A1
(43) Pub. Date: Aug. 5, 2004

(54) Submission data managing system and submission data managing method

(75) Inventor: Toshio Furuta, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC CORPORATION

(21) Appl. No.: 10/659,441

(22) Filed: Sep. 11, 2003

(30) Foreign Application Priority Data
Sep. 12, 2002 (JP) 267334/2002

(51) Int. Cl. G06F 15/16

(52) U.S. Cl. 709/204

(57) ABSTRACT

A submission data managing system includes a submission data storing unit, a list screen supplying unit and a submission data supplying unit. The submission data storing unit stores a submission data and a class data, wherein the submission data is submitted by any one of members in an electronic forum, and the class data indicates any one of classes to which the submission data belongs. The list screen supplying unit outputs a list screen data to a terminal of the one of members, in response to a request for the list screen data from the terminal, wherein the list screen data indicates a list of the submission data in the one of classes stored in the submission data storing unit. The submission data supplying unit outputs the submission data to the terminal, in response to a request for the submission data selected from the list from the terminal. The class data is supplied with the submission data, the submission data storing unit relates the submission data to the class data while storing the submission data and the class data.

### FIELD OF THE INVENTION

The present invention relates to a submission data managing system and a submission data managing method, more particularly, the present invention relates to a submission data managing system and a submission data managing method for managing a data submitted by a plurality of persons belonging to a certain group.

### DESCRIPTION OF THE RELATED ART

The propagation of a computer leads to the wide usage of data and information transmitting manner of using a computer. Then, an electronic forum (hereinafter referred to as an e-forum) is widely operated for exchanging the data and information with regard to a particular topic by using a computer and a communication network. For example, in many cases, a corporation operates an e-forum for employees and urges the employees to exchange the data and information with regard to operations.

As the data and information transmitting method of using the computer, there is a method of using an electronic mail (hereinafter referred to as an e-mail). In particular, in the e-forum, a mailing list service is provided in many cases. In the mailing list service, an e-mail address of each of members in the e-forum is registered in a mailing list server. The mailing list server, when receiving an e-mail from a certain member, transfers the e-mail to the respective members. Thus, the member in the e-forum, if transmitting an e-mail to the mailing list server, can transmit information to the other members.

The usage of the e-mail enables the easy transmission of data and information. However, this brings about the problem of the overflow of the data and information that results in the heavy burden of data and information management. In order to solve such problem, a time series information managing apparatus is proposed. When receiving a first e-mail with regard to a certain main subject, the time series information managing apparatus assigns a management number to the main subject so that the information is managed for each management number (for example, refer to Japanese Laid Open Patent Application (JP-A 2002-132801)). This time series information managing apparatus, when assigning the management number, reports the management number through the e-mail to concerned members. The concerned member, if transmitting the information related to this main subject, transmits the e-mail indicative of the reported management number to the time series information managing apparatus. The time series information managing apparatus manages the received e-mail for each management number and also records a reception time. The time series information managing apparatus, when receiving a data retrieval command from a user, specifies the management number related to a keyword inputted by the user. Then, it indicates in time series each data to which the management numbers is assigned.

Also, a mail box managing method of storing each of e-mails in a proper mail box by providing a plurality of mail boxes is proposed in order to reduce the management burden of received e-mails (for example, refer to Japanese Laid Open Patent Application (JP-A-Heisei 6-250950)). This mail box managing method stores each of the received e-mails in the mail box corresponding to the information attached to the e-mail (for example, a title of the e-mail, a transmitting person, a transmitted date or the like). Also, if a user specifies a mail box and indicates a deletion within the mail box or the like, it specifies the e-mail within the mail box and then executes the indicated command (the deletion or the like).

Also, a service is provided in which respective members in an e-forum can submit data and the data can be shared. For example, FROMSEEDDOTCOM K. K provides a service under a name of [Furufuru Communicator] (refer to the URL below). The [Furufuru Communicator] receives the submissions from the respective members in the e-forum through an electronic bulletin board. The manager of the e-forum checks the respective submitted data and arranges and stores the important data. Concretely, it prepares a folder for storing the important data, and stores the important data in the folder. Each of the members can access a server of the Furufuru Communicator from a terminal and read the respective submitted data. Also, each of the members can identify the data stored in the folder as the important data.

The list of URL of Furufuru Communicator (From-c.com Co.) is shown below. [symbol] (Furufuru Office) pages 1 to 4

<URL:http://210.226.240.183/from-c/furufuru/ [symbol] [symbol] _fig001.htm>

<URL:http://210.226.240.183/from-c/furufuru/ [symbol] [symbol] _fig002.htm>

<URL:http://210.226.240.183/from-c/furufuru/ [symbol] [symbol] _fig003.htm>

<URL:http://210.226.240.183/from-c/furufuru/ [symbol] [symbol] _fig004.htm>

(Retrieval in Aug. 30, 2002)

<URL:http://www3.from-c/from-c/furufuru/ [symbol] [symbol] _fig001-fig004.htm>

(Retrieval in Sep. 2, 2003)

[symbol]

[symbol]

(The demonstration of Furufuru Office)

<URL:http://www.from-c.com/demo/>

<URL:http://210.226.240.183/cgi-bin/gw1/forum/list_next.pl?conf=/cgi-bin/gw1/conf_demo.pl&id

=demo&u_id=demo&forumid=demo_inter&F_D ESIGN=>

<URL:http://210.226.240.183/cgi-bin/gw1/forum/list_next.pl?conf=/cgi-bin/gw1/conf_demo.pl&id

=demo&u_id=demo&syoko_sw=syoko&forumid =demo_inter_s&F_DESIGN=>

<URL:http://210.226.240.183/cgi-bin/gw1/forum/list_next.pl?conf=/cgi-bin/gw1/conf_demo.pl&id

=515&forumid=demo_inter&F_DESIGN=&id=d emo&u_id=demo&syoko_sw=>

(Retrieval in Aug. 30, 2002)

(The URL of “Furufuru Office demo” could not be accessed in Sep. 2, 2003.)

The server of the Furufuru Communicator, when receiving a reading request from the terminal of each of the members, urges the member to transmit a user ID and a password. Then, it allows the member to read the data if the authentication through the user ID and the password is successful. After that, the member uses the terminal and reads the electronic bulletin board or indicates a folder and reads the data within the folder.

An example of a user interface screen of the Furufuru Communicator is disclosed. One of the disclosed screen examples displays the situation when an authentication is successful. Icons of [Internet Research Circle] and [Internet Research Circle Library] are icons to call the specific screens, respectively. The disclosed list example displays respective submissions. Another of the disclosed screen examples displays the situation when a folder or an data stored in the folder is called. However, the disclosed screen displays the case when the data is not stored in the folder. Thus, the list of the data in the folder is not displayed. The member can read the submitted data by mouse-clicking a listed displayed title.

In the Furufuru Communicator, the manager checks the submitted data, and stores the important data in the folder, and thereby arranges the submitted data. However, there may be a case that since the manager is busy, the manager can not check the submitted data and can not store it in the folder. Typically, the members in the e-forum except the manager do not have the temporal margin to carry out the work for arranging the data. Thus, if the manager can not arrange the data, the data submitted by the respective members are merely accumulated. Then, for the members, it is difficult to discriminate between the important data and the unimportant data.

Also, each of the members must input the user ID and the password when reading the data. The inputs of the user ID and the password each time the data is read become the burden of each of the members.

Also, each of the members in the e-forum may possibly desire to publish data to only a part of the members. For this reason, it is desirable that the particular data can be read by only the part of the members.

Therefore, the technique which enables to reduce a burden of data arrangement of an electronic forum manager and a burden of data access and read of members has been desired. Also, the technique which enables to limit an access to data based on a right of access members has been desired.

In conjunction with the above description, Japanese Laid Open Patent Application (JP-A-Heisei 6-152643) discloses the following the electronic bulletin board service method in message accumulation exchanging apparatus.

The object is to provide the method which enables an electronic bulletin board registration data to be automatically distributed to a preliminarily defined subscriber, when a data is registered in an electronic bulletin board, in an electronic bulletin board service of a message accumulation exchanging apparatus.

The method includes an electronic bulletin board data registration processing unit; an electronic bulletin board distribution request managing unit; an electronic bulletin board distribution processing unit; and a subscriber distribution request managing unit. The electronic bulletin board data registration processing unit carries out an accumulating process when a data to be displayed on an electronic bulletin board, in an electronic bulletin board service in the message accumulation exchanging apparatus. The electronic bulletin board distribution request managing unit manages a request of an automatic distribution to a preliminarily defined subscriber, when the data is registered in the electronic bulletin board. The electronic bulletin board distribution processing unit carries out a process to distribute the data in the electronic bulletin board to the preliminarily defined subscriber, when there is a request from this electronic bulletin board distribution request managing unit. The subscriber distribution request managing unit manages a distribution request to the subscriber requested from the electronic bulletin board distribution request managing unit.

Japanese Laid Open Patent Application (JP-A 2001-344257) discloses the following the network community supporting method and system.

The object is to provide the system to analyze a series of statement contents of network community participants, and carry out a matching between an object of an operational body of a community and an interest of a participant layer, and then obtain a property of a lifestyle of a user layer, which is the object of the operational body of the community and the like, and a potential need.

The system includes a statement database; a theme database; a theme classifying unit; and a unit for making a theme the newest. The statement database stores a series of statement contents of network community participants, in the network community supporting system. The theme database stores a theme of a network community. The theme classifying unit classifies the statements stored in the statement database, in accordance with the theme stored in the theme database. The unit for making a theme the newest makes the theme database the newest, in accordance with a theme classification result through the theme classifying unit for the statement.

### SUMMARY OF THE INVENTION

Therefore, an object of the present invention is to provide a technique which enables to reduce a burden of data arrangement of an electronic forum manager and a burden of data access and read of members.

Another object of the present invention is to provide a technique which enable to limit an access to data based on a right of access members.

In order to achieve an aspect of the present invention, the present invention provides a submission data managing system including: a submission data storing unit, a list screen supplying unit, and a submission data supplying unit. The submission data storing unit stores a submission data and a class data, wherein the submission data is submitted by any one of members in an electronic forum, and the class data indicates any one of classes to which the submission data belongs. The list screen supplying unit outputs a list screen data to a terminal of the one of members, in response to a request for the list screen data from the terminal, wherein the list screen data indicates a list of the submission data in the one of classes stored in the submission data storing unit. The submission data supplying unit outputs the submission data to the terminal, in response to a request for the submission data selected from the list from the terminal. The class data is supplied with the submission data, the submission data storing unit relates the submission data to the class data while storing the submission data and the class data.

In the submission data managing system of the present invention, the submission data storing unit receives the submission data with the class data through an electronic mail.

In the submission data managing system of the present invention, the submission data storing unit judges the class data by referring to a data in a subject field of the electronic mail.

In the submission data managing system of the present invention, the list screen supplying unit generates and outputs an input screen data indicating an input screen displayed on the terminal which urges the member to input the submission data and the class data.

In the submission data managing system of the present invention, the list screen data for each one of classes is identified by URL (Uniform Resource Locator). The list screen supplying unit outputs the list screen data corresponding to the URL, in response to a request for the list screen data by using the URL from the terminal.

In the submission data managing system of the present invention, the list screen supplying unit outputs a list screen link data to the terminal, in response to a request for the list screen link from the terminal, the list screen link data includes link to the list screen data.

The submission data managing system of the present invention, further includes a user data storing unit which stores a user data which relates the one of members to one of rights, wherein the one of rights is a right to access submission data in a predetermined class. The list screen supplying unit outputs the list screen link data to the terminal, the list screen link data includes link to the list screen data corresponding to the predetermined class, in response to a request for the list screen link data from the terminal.

In the submission data managing system of the present invention, the predetermined class is anon-publication class. The list screen supplying unit outputs the list screen link data in which link to the list screen data including the non-publication class are set, in response to a request for the list screen link data from the terminal having the one of rights.

In the submission data managing system of the present invention, the list screen supplying unit outputs the list screen link data in which link to the list screen data excluding the non-publication class are set, in response to a request for the list screen link data from the terminal not having the one of rights.

The submission data managing system of the present invention, further includes a user data storing unit which stores a user data which relates the one of members to one of rights, wherein the one of rights is a right to access submission data in a predetermined class. The submission data storing unit relates the submission data to a priority data which is predetermined based on the one of classes, while storing the submission data. The list screen supplying unit outputs the list screen link data to the terminal, the list screen link data includes link to the list screen data corresponding to the priority data, in response to a request for the list screen link data from the terminal.

The submission data managing system of the present invention, further includes a latest data reporting unit which sends the list of the submission data received for each certain period, every the certain period to a manager terminal. The submission data supplying unit outputs the submission data to the manager terminal, in response to a request for the submission data received for each certain period from the manager terminal.

In order to achieve another aspect of the present invention, the present invention provides a submission data managing method, including: (a) storing a submission data and a class data, wherein the submission data is submitted by any one of members in an electronic forum, and the class data indicates any one of classes to which the submission data belongs; (b) outputting a list screen data to a terminal of the one of members, in response to a request for the list screen data from the terminal, wherein the list screen data indicates a list of the submission data in the one of classes stored; and (c) outputting the submission data to the terminal, in response to a request for the submission data selected from the list from the terminal. The class data is supplied with the submission data, the submission data is related to the class data while storing the submission data and the class data.

The submission data managing method of the present invention, the step (a) including: (a1) receiving the submission data with the class data through an electronic mail.

The submission data managing method of the present invention, the step (a) further including: (a2) judging the class data by referring to a data in a subject field of the electronic mail.

The submission data managing method of the present invention, the step (b) including: (b1) generating and outputting an input screen data indicating an input screen displayed on the terminal which urges the member to input the submission data and the class data.

The submission data managing method of the present invention, the list screen data for each one of classes is identified by URL (Uniform Resource Locator). The step (b) including: (b2) outputting the list screen data corresponding to the URL, in response to a request for the list screen data by using the URL from the terminal.

The submission data managing method of the present invention, the step (b) including: (b3) outputting a list screen link data to the terminal, in response to a request for the list screen link from the terminal, the list screen link data includes link to the list screen data.

The submission data managing method of the present invention, further including: (d) storing a user data which relates the one of members to one of rights, wherein the one of rights is aright to access submission data in a predetermined class. The step (b3) including: (b31) outputting the list screen link data to the terminal, the list screen link data includes link to the list screen data corresponding to the predetermined class, in response to a request for the list screen link data from the terminal.

The submission data managing method of the present invention, further including: (e) storing a user data which relates the one of members to one of rights, wherein the one of rights is aright to access submission data in a predetermined class. The step (a) including: (a3) relating the submission data to a priority data which is predetermined based on the one of classes, while storing the submission data. The step (b3) including: (b32) outputting the list screen link data to the terminal, the list screen link data includes link to the list screen data corresponding to the priority data, in response to a request for the list screen link data from the terminal.

The submission data managing method of the present invention, further including: (f) sending the list of the submission data received for each certain period, every the certain period to a manager terminal. The step (c) including: (c1) outputting the submission data to the manager terminal, in response to a request for the submission data received for each certain period from the manager terminal.

In order to achieve still another aspect of the present invention, the present invention provides a computer program product embodied on a computer-readable medium and including code that, when executed, causes a computer to perform the following: (a) storing a submission data and a class data, wherein the submission data is submitted by any one of members in an electronic forum, and the class data indicates any one of classes to which the submission data belongs; (b) outputting a list screen data to a terminal of the one of members, in response to a request for the list screen data from the terminal, wherein the list screen data indicates a list of the submission data in the one of classes stored; and (c) outputting the submission data to the terminal, in response to a request for the submission data selected from the list from the terminal. The class data is supplied with the submission data, the submission data is related to the class data while storing the submission data and the class data.

In the computer program of the present invention, the step (a) including: (a1) receiving the submission data with the class data through an electronic mail.

In the computer program of the present invention, the step (a) further including: (a2) judging the class data by referring to a data in a subject field of the electronic mail.

In the computer program of the present invention, the step (b) including: (b1) generating and outputting an input screen data indicating an input screen displayed on the terminal which urges the member to input the submission data and the class data.

In the computer program of the present invention, the list screen data for each one of classes is identified by URL (Uniform Resource Locator). The step (b) including: (b2) outputting the list screen data corresponding to the URL, in response to a request for the list screen data by using the URL from the terminal.

In the computer program of the present invention, the step (b) including: (b3) outputting a list screen link data to the terminal, in response to a request for the list screen link from the terminal, the list screen link data includes link to the list screen data.

The computer program of the present invention, further including: (d) storing a user data which relates the one of members to one of rights, wherein the one of rights is a right to access submission data in a predetermined class. The step (b3) including: (b31) outputting the list screen link data to the terminal, the list screen link data includes link to the list screen data corresponding to the predetermined class, in response to a request for the list screen link data from the terminal.

The computer program of the present invention, further including: (e) storing a user data which relates the one of members to one of rights, wherein the one of rights is a right to access submission data in a predetermined class. The step (a) including: (a3) relating the submission data to a priority data which is predetermined based on the one of classes, while storing the submission data. The step (b3) including: (b32) outputting the list screen link data to the terminal, the list screen link data includes link to the list screen data corresponding to the priority data, in response to a request for the list screen link data from the terminal.

The computer program of the present invention, further including: (f) sending the list of the submission data received for each certain period, every the certain period to a manager terminal. The step (c) including: (c1) outputting the submission data to the manager terminal, in response to a request for the submission data received for each certain period from the manager terminal.

### BRIEF DESCRIPTION OF THE DRAWINGS

FIG. 1 is a block diagram showing an embodiment of a submission data managing system according to the present invention;

FIG. 2A is a view showing an example of the entire screen;

FIGS. 2B to 2E are views respectively showing examples of the list screens of the respective libraries;

FIG. 3 is a table showing the data structure of the management database 7;

FIG. 4 is a table showing an example of the user data 8;

FIG. 5 is a view showing an example of the e-mail in which the link to each list screen is set;

FIG. 6 is a flowchart showing an example of the process of the embodiment according to the present invention;

FIG. 7 is a flowchart showing another example of the process of the embodiment according to the present invention;

FIG. 8 is a flowchart showing an example of the process of the step 04 and the step S13;

FIG. 9 is a flowchart showing another example of the process of the embodiment according to the present invention;

FIG. 10A is a first half of a flowchart showing another example of the process of the embodiment according to the present invention;

FIG. 10B is a second half of the flowchart showing another example of the process of the embodiment according to the present invention;

FIG. 11 is a view showing an example of a display screen of the text data;

FIG. 12 is a view showing the example of the user data 8;

FIG. 13 is a flowchart showing another example of the process of the embodiment according to the present invention;

FIG. 14A is a first half of a flowchart showing another example of the process of the embodiment according to the present invention;

FIG. 14B is a second half of the flowchart showing another example of the process of the embodiment according to the present invention; and

FIG. 15 is a view showing an example of an e-mail.

### Description of the Preferred Embodiment

An embodiment of a submission data managing system according to the present invention will be described below with reference to the attached drawings. Here, a case is explained as an example, in which an employee in charge of a business related to a biotechnology in a company is a member in an electronic forum (hereinafter referred to as e-forum). This invention may be applied to a system for an electronic bulletin board and electronic conference.

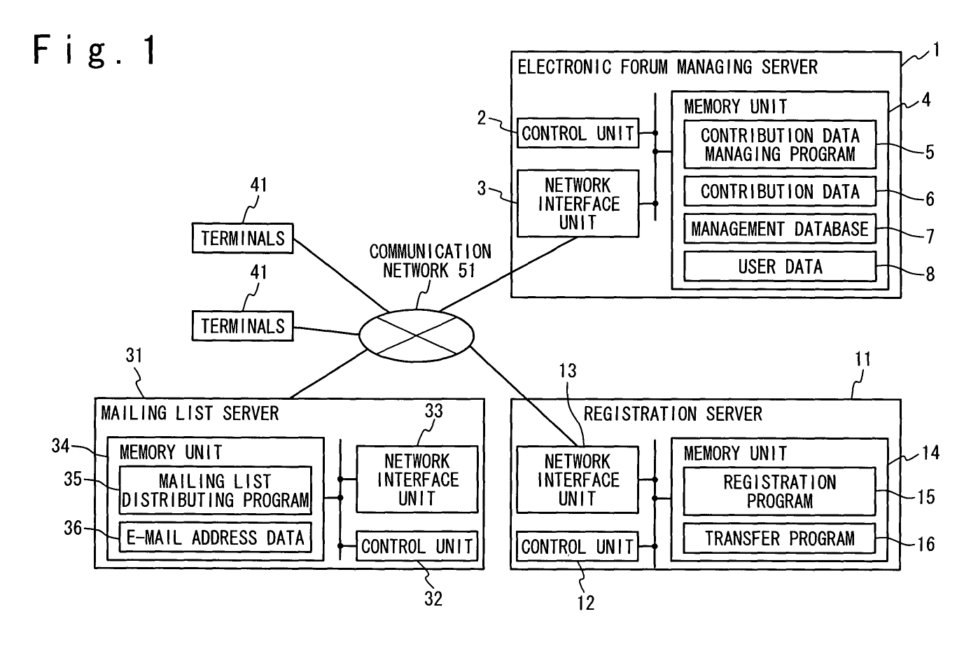

FIG. 1 is a block diagram showing an embodiment of a submission data managing system according to the present invention. The submission data managing system includes an electronic forum managing server 1, a registration server 11 and a mailing list server 31. The electronic forum managing server 1, the registration server 11 and the mailing list server 31 are connected through a communication network 51. Also, terminals 41 used by the member in the e-forum are connected to the communication network 51. The respective units shown in FIG. 1 transmit and receive data through the communication network 51. The communication network 51 is, for example, LAN, WAN, Internet and the like.

Each of the terminals 41 is an information (data) processor. That is used by the member in the e-forum for transmitting and/or receiving electronic mail (hereinafter referred to as e-mail) and reading the data registered in the electronic forum managing server 1. Each terminal 41 includes a mailer (an e-mail software) and a browser. Here, the terminal 41 includes the mailer that follows the various rules employed by the submission data managing system. For example, if the submission data managing system employs the rules such as RFC (Request for Comments) 2822, RFC2045 to RFC2049, the terminal 41 includes the mailer following the rules. Those RFCs contain the rules such as SMTP (Simple Mail Transfer Protocol), POP (Post Office Protocol).

The mailers, which follow RFC2822 and RFC2045 to RFC2049, are exemplified as Becky (mailer's name), AL-Mail (mailer's name) and a mailer for a computer made by Apple Computer Inc. Also, in a case of using a mail client function of a product such as [Lotus Notes (a registered trademark)], if a main sentence contains a Japanese explanation as well as an English explanation, the encoding of the main sentence is carried out by Base 64. Even in this case, it follows RFC2822 and RFC2045 to RFC2049. Thus, the terminal 41 may use the mail client functions, such as [Lotus Notes] and the like, and transmit or receive the e-mail.

E-mail addresses of the members in the e-forum related to the biotechnology are registered in advance in the mailing list server 31 as a mailing list. Then, when the mailing list server 31 receives an e-mail for e-mail address of the mailing list from the terminal 41, it transfers the e-mail to the respective members in the e-forum. Also, an e-mail address is assigned to the registration server 11 similarly to the members in the e-forum. The e-mail address assigned to the registration server 11 is also registered in the mailing list server 31 as the e-mail address of the member in the e-forum. Thus, the mailing list server 31, when receiving an e-mail from a terminal 41 of a certain member, transfers the e-mail not only to the terminals 41 of the members in the e-forum but also to the registration server 11.

The registration server 11, when receiving the e-mail from the mailing list server 31, transfers the e-mail to the electronic forum managing server 1. Also, each terminal 41 may transmit the e-mail in which the e-mail address of the registration server 11 is defined as the transmission destination. Also in this case, the registration server 11 transfers the received e-mail to the electronic forum managing server 1. In this case, the e-mail transmitted by the terminal 41 is never transferred to the respective members.

The electronic forum managing server 1, when receiving the e-mail from the registration server 11, stores data written in the e-mail and files attached to the e-mail as submission data. Also, the electronic forum managing server 1 defines in advance the class into which the e-mail having a high importance is classified. Then, if the class is indicated in the e-mail, the submission data is correlated with the class and stored. Incidentally, the member, when indicating the class, writes the class to a predetermined column (for example, a subject field that is the column of a title of an e-mail).

Here, the classes of the e-mail are defined as [Report], [Proposal], [Correspondence/Negotiation] and [Non-Publication]. The [Report] is the class into which an e-mail having a report to a supervisor is classified. The [Proposal] is the class into which an e-mail having a proposal item on a business is classified. The [Correspondence/Negotiation] is the class into which an e-mail having a client data is classified. And, the [Non-Publication] is the class into which an e-mail having a non-publication data (for example, data with regard to personnel affairs and accounting) is classified. In the following explanation, those classes are noted as [Library].

Also, the electronic forum managing server 1 provides to the respective terminals 41 the list screens on which the list data of the stored e-mails are displayed. This screen is prepared for each library. For example, the list data of the e-mail stored while correlated with the library of the [Report] is displayed on the list screen of the [Report] library. Also, the electronic forum managing server 1 provides the list screen on which the list data of all of the e-mails except the e-mail of a [Non-Publication] library is displayed. This screen is noted as [Entire Screen].

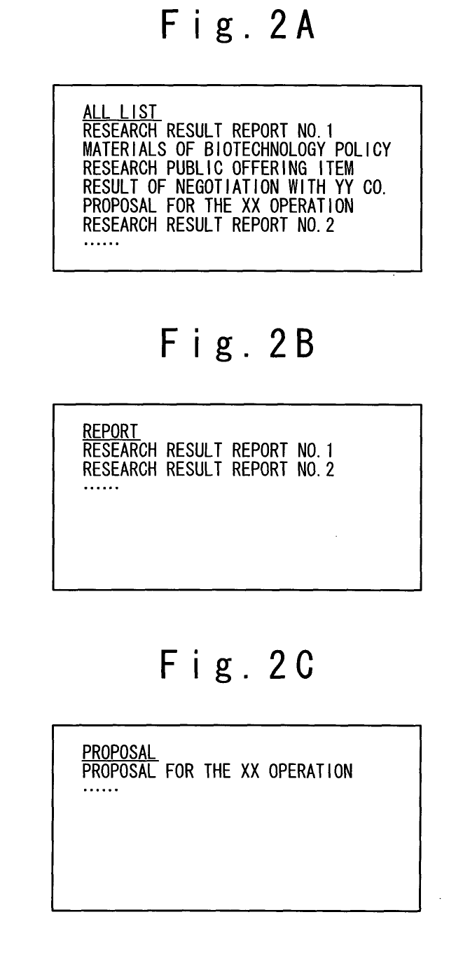

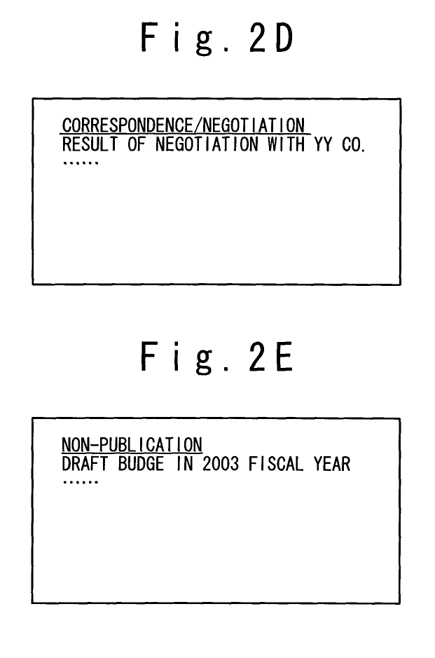

FIG. 2A is a view showing an example of the entire screen (All List). Also, FIGS. 2B to 2E are views respectively showing examples of the list screens of the respective libraries. As shown in FIGS. 2A to 2E, the list of the e-mails displayed on the list screens of the [Report], the [Proposal] and the [Correspondence/Negotiation] is displayed even on the entire screen. Also, since the entire screen displays thereon all of the e-mails except the e-mail of the [Non-Publication] library, even the e-mail whose library is not indicated is included in the list of the entire screen. For example, when an e-mail under a title of [Research Public Offering Item] is transmitted without any indication of a library, the [Research Public Offering Item] is not displayed on the list screen of each library, but it is displayed on the entire screen. Also, when an e-mail under a title of [Research Result Report No.1] with the [Report] as the library is transmitted, the [Research Result Report No.1] is displayed on the list screen of the [Report] library and the entire screen. Also, when an e-mail under a title of [Draft Budge in 2003 Fiscal Year] with the [Non-Publication] as the library is transmitted, the [Draft Budget in 2003 Fiscal Year] is not displayed on the entire screen, but it is displayed on the screen of the [Non-Publication] library.

The member in the e-forum searches for the desired data through the entire screen and the list screens of the respective libraries, and reads the data. For example, in the terminal 41, a member mouth-clicks the [Research Result Report 1] on the entire screen. Then, the electronic forum managing server 1 receives the reading request of the e-mail from the terminal 41, and transmits the data noted in the [Research Result Report 1]. The terminal 41 displays thereon the data received from the electronic forum managing server 1, and thereby allows the member to read. However, the submission data in the [Non-Publication] library can be read by only the member having a special right among the members.

Incidentally, the e-mail in which the [Non-Publication] is indicated as the library must not be distributed as the mailing list to the respective members. So, for example, each of the members, when indicating the library, defines the e-mail address of the registration server 11 as the transmission destination and carries out the transmission, and when not indicating the library, defines the e-mail address of the mailing list as the transmission destination and carries out the transmission. Consequently, the e-mail in which the library is indicated is not distributed to the registration member of the mailing list. Thus, the non-publication data is not transmitted to the respective members, and it is registered in the electronic forum managing server 1. On the other hand, the e-mail in which the library is not indicated is distributed to the respective members and then registered in the electronic forum managing server 1.

Here, the example in which the transmission destination of the e-mail is changed between the case when the library is indicated and the case when the library is not indicated is explained. However, the e-mail in which the library except the [Non-Publication] is indicated may be distributed to the respective members. Thus, when indicating the library except the [Non-Publication], the member may define the e-mail address for the mailing list as the transmission destination.

The configurations of the respective units will be described below.

The electronic forum managing server 1, which is exemplified in the workstation and the personal computer, includes a control unit 2, a network interface unit 3 and a memory unit 4. The memory unit 4 stores software and data such as a submission data managing program 5, a submission data 6, a management database 7 and an user data 8.

The control unit 2 is operated in accordance with the submission data managing program 5. The submission data managing program 5 is the program for instructing the control unit 2 to execute the processes described in this embodiment. Those are processes such as the process for storing a received e-mail in accordance with the indication of the library and the process for transmitting the data in accordance with the request from the terminal 41. The network interface unit 3 transmits and receives data to and from a different unit through the communication network 51.

The memory unit 4 stores the data (for example, a main sentence, a title and an attached file of the e-mail) of the e-mail transmitted by each of the members in the e-forum as the submission data 6. The electronic forum managing server 1 manages the submission data 6 by using a management database 7.

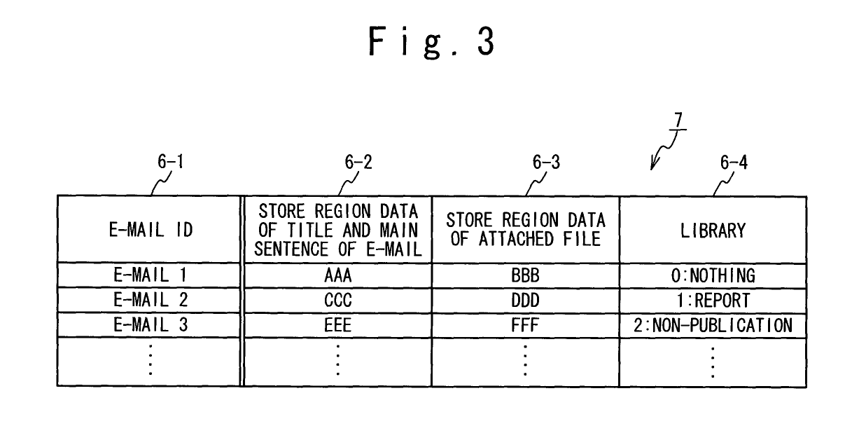

FIG. 3 is a table showing the data structure of the management database 7. As shown in FIG. 3, for each e-mail, the management database 7 includes the e-mail ID 6-1, the store region data of the title and the main sentence of the e-mail 6-2, the store region data of the attached file 6-3, and the library 6-4 indicated by the e-mail. They are related to each other.

Here, the e-mail ID 6-1 is determined by the control unit 2. Hereafter, the tile and the main sentence of the e-mail are referred to as a text data. The store region data (6-2, 6-3) is, for example, the data indicating a file name, a directory and an address of the stored text data and the attached file.

The control unit 2, when receiving the e-mail from the registration server 11, refers to the subject field of the e-mail and thereby judges a submission type. If the library is not indicated, the control unit 2 judges as a submission type 0. The submission type 0 implies that although the title of the e-mail is displayed on the entire screen, it is not displayed on the list screen of the library. If the library except the [Non-Publication] is indicated, the control unit 2 judges as a submission type 1. The submission type 1 implies that the title of the e-mail is displayed on both of the entire screen and the list screen of the indicated library. If the [Non-Publication] is indicated as the library, the control unit 2 judges as a submission type 2. The submission type 2 implies that the title is displayed only on the list screen of the [Non-Publication] library.

Here, the control unit 2 judges the e-mail, which designates a list request command that will be described later, as a submission type 3.

If the submission type of the received e-mail is 0, the control unit 2 stores the text data and the attached file of the e-mail in the memory unit 4. Then, it registers the store region data of the text data and the attached file in the management database 7. Also, the library data to be registered together with the store region data is assumed to be, for example, [Nothing].

If the submission type is 1, the control unit 2 stores the text data and the attached file in the memory unit 4, similarly to the case of the submission type 0, and then registers the store region data in the management database 7. Also, the indicated library data is registered together with the store region data.

If the submission type of the received e-mail is 2, the control unit 2 judges whether or not the e-mail is to be registered based on the user data 8.

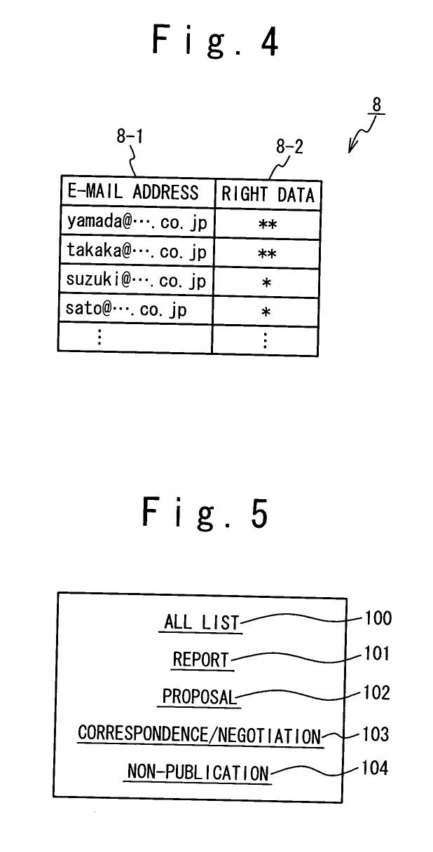

FIG. 4 is a table showing an example of the user data 8. The user data 8 includes the e-mail addresses 8-1 of the respective members in the e-forum and the right data 8-2 indicating the rights of the members to accessing data. The e-mail address 8-1 corresponding to the each member is related to the right data 8-2 of each member. In the example shown in FIG. 4, [*] represents the member who can not read (access) the e-mail in the [Non-Publication] library (hereafter, referred to as a common member). [**] represents the member having a special right who can read (access) the e-mails in the respective libraries including the [Non-Publication] (hereafter, referred to as a special member).

If the submission type is 2, the control unit 2 collates a mail address of a transmitting person of the e-mail with the user data 8. If the transmitting person is the common member, it reports the rejection of the registration to that member through the e-mail. If the transmitting person is the special member, it stores the text data and the attached file of the e-mail and then registers the store region data in the management database 7. Also, it registers the [Non-Publication] as the indicated library data.

There may be a case that the text data is not noted in the e-mail and only the file is attached thereto. If the text data is not noted, it is allowable that the control unit 2 does not register the store region data of the title and the main sentence of the e-mail 6-2 in the management database 7.

Similarly, there may be a case that the text data is noted and the file is not attached. If the file is not attached, it is allowable that the control unit 2 does not register the store region data of the attached file 6-3 in the management database 7.

It is allowable that the text data includes the data of the transmission date of the e-mail and the transmission destination thereof. Then, not only the title and the main sentence but also the transmission date and the transmission destination and the like may be displayed on the screen indicative of the content of the submission data.

If the data on each of the screens exemplified in FIGS. 2A to 2E is transmitted, the control unit 2 sets the link to the screen indicating the content of the e-mail, for each of the displayed titles. Then, when the individual title is mouth-clicked, it transmits the screen indicating the content to the terminal 41.

Also, URL is defined for the entire screen and the list screens of the respective libraries. In accordance with the operation of the user, when the terminal 41 indicates URL and then requests each screen, the control unit 2 transmits to the terminal 41 the data of the list screen and the entire screen specified by the URL.

Also, the control unit 2 receives the list request command (hereafter, referred to as a LIST command) for requesting the e-mail in which the link to the list screen in each library is set.

FIG. 5 is a view showing an example of the e-mail in which the link to each list screen is set. The control unit 2, when receiving the LIST command, returns the e-mail exemplified in FIG. 5. Link setting portions 100 to 104 shown in FIG. 5 are related with the URLs on the list screens of the [Report] (101), the [Proposal] (102), the [Correspondence/Negotiation] (103), the [Non-Publication] (104) and all list (100), respectively. The all list 100 includes all the lists corresponding to the [Report] (101), the [Proposal] (102), the [Correspondence/Negotiation] (103) and the [Non-Publication] (104). The links to the respective list screens are set in these link setting portions. However, the e-mail transmitted to the common member does not include the link setting portion 104. The all list (100) may not be displayed.

In the terminal 41, when one of the link setting portions 101 to 103 shown in FIG. 5 is mouth-clicked, the terminal 41 requests corresponding one of the list screens of the [Report], the [Proposal] and the [Correspondence/Negotiation]. When the link setting portion 104 is mouth-clicked, the terminal 41 requests the list screen of the [Non-Publication]. The control unit 2 transmits to the terminal 41 any of the screens exemplified in FIGS. 2B to 2E, in accordance with the request from the terminal 41.

The Mailing list server 31, which is exemplified in the workstation and the personal computer, includes a control unit 32, a network interface unit 33 and a memory unit 34. The memory unit 34 stores software and data such as a mailing list distributing program 35 and an e-mail address data 36.

The control unit 32 is operated in accordance with the mailing list distributing program 35. The mailing list distributing program 35 is the program for instructing the control unit 32 to execute the process for transmitting the e-mails received from the respective terminals 41 to the participators (namely, the members in the e-forum) of the mailing list. The network interface unit 33 transmits and receives data to and from a different unit through the communication network 51.

The e-mail address data 36 are the e-mail addresses of the respective members in the e-forum. The control unit 32 receives the e-mail in which the e-mail address for the mailing list is defined as the transmission destination. Then, it transmits the e-mail to the respective members based on the e-mail address data 36. The e-mail address data 36 includes the e-mail address assigned to the registration server 11.

The registration server 11, which is exemplified in the workstation and the personal computer, includes a control unit 12, a network interface unit 13 and a memory unit 14. The memory unit 14 stores software and data such as a registration program 15 and a transfer program 16.

The control unit 12 transfers the e-mails received from the respective terminals 41 and the Mailing list server 31 to the electronic forum managing server 1, in accordance with a transfer program 16 stored in a memory unit 14. The network interface unit 13 transmits and receives data to and from a different unit through the communication network 51.

In this embodiment, the submission data storing unit, the list screen displaying unit, the submission data displaying unit and the input screen displaying unit are attained by the network interface unit 3 and the control unit 2 of the electronic forum managing server 1. The user data storing unit is attained by the memory unit 4. Also, the memory unit 4 stores the submission data managing program to enable the computer to attain: the function of classifying the received submission data in accordance with the class data received together with the submission data and then storing in the memory; the function of displaying the list screen indicative of the list of the received submission data on the terminal for each class, in accordance with the request from the terminal of the member; and the function of transmitting the submission data selected from the list to the terminal.

The operation of the embodiment of a submission data managing system according to the present invention will be described below.

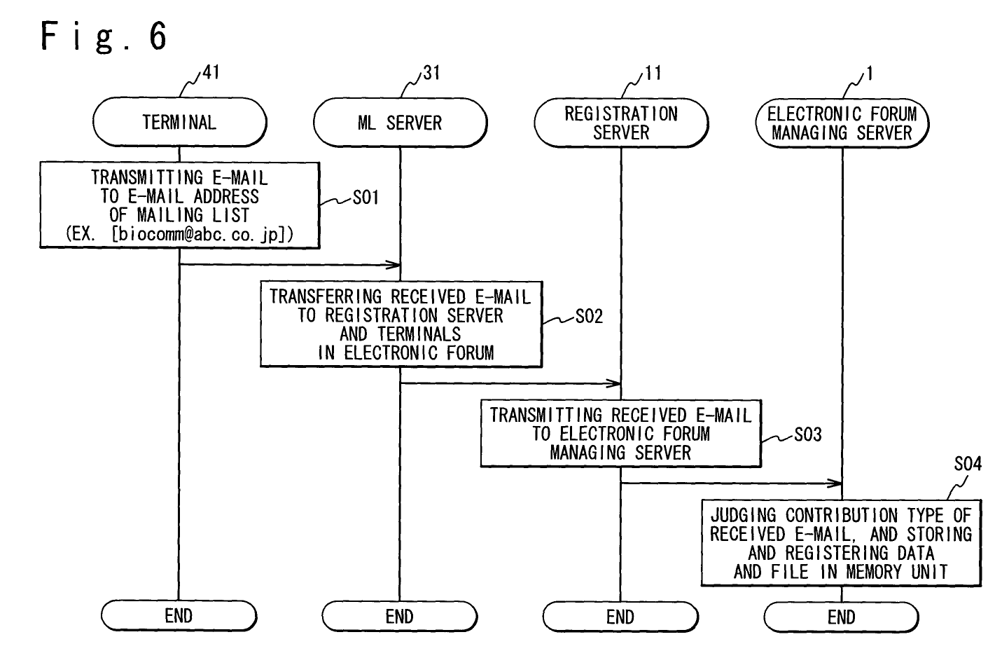

FIG. 6 is a flowchart showing an example of the process when the member in the e-forum submits the data by using the e-mail. FIG. 6 shows the example in which the mailing list server 31 distributes the e-mail to the respective members, and then registers the submission content in the electronic forum managing server 1. Here, the Mailing list server 31 uses an address of [biocomm@abc.co. jp] as an e-mail address for a mailing list in a biotechnology relation business e-forum. Also, here, an e-mail address of [biocoml@abc.co.jp] is assigned to the registration server 11.

The terminal 41 transmits the e-mail in which the e-mail address for the mailing list of [biocomm@abc.co.jp] is defined as a transmission destination, in accordance with the operation of the member in the e-forum (step S01). In the step S01, the member, when indicating a library, designates the library in a predetermined format on the subject field of the e-mail. For example, the member, after writing a title, designates the library in a format of [<<LIB NP Library Name>>]. In this case, when the member indicates the [Report] library, the [<<LIB NP Report>>] may be written after the title. Also, when the member does not indicate the library, it is enough to write only the title on the subject field. However, when the e-mail address for the mailing list of [biocomm@abc.co.jp] is defined as the transmission destination, the member does not indicate the [Non-Publication] library.

The Mailing list server 31 receives the e-mail in which the [biocomm@abc.co.jp] is defined as the transmission destination. Then, the control unit 32 refers to the e-mail address data 36 stored in advance. Then, it transfers the received e-mail to the member of the biotechnology relation business e-forum, based on the e-mail address data 36. The e-mail address data 36 includes even the e-mail address of the [biocoml@abc.co.jp] assigned to the registration server 11. Thus, the control unit 32 also transmits the e-mail to the registration server 11, similarly to the respective members (Step S02). Incidentally, the control unit 32 defines as a transmission source the e-mail address of the member transmitting the e-mail in the step S01.

The control unit 12 of the registration server 11 transmits the e-mail to the electronic forum managing server 1, when receiving the e-mail to the [biocoml@abc.co.jp] (Step S03). The control unit 12 uses the e-mail address of the member transmitting the e-mail at the step S01 as the transmission source, and transmits it in its original state without adding any change to the portion where the [<<LIB NP Library Name>>] on the subject field is noted.

The control unit 2 of the electronic forum managing server 1 refers to the subject field and thereby judges the submission type, when receiving the e-mail from the registration server 11. Then, in accordance with the submission data, it stores the text data and the attached file of the e-mail as the submission data 6 in the memory unit 4 (Step S04).

Another operation of the embodiment of a submission data managing system according to the present invention will be described below.

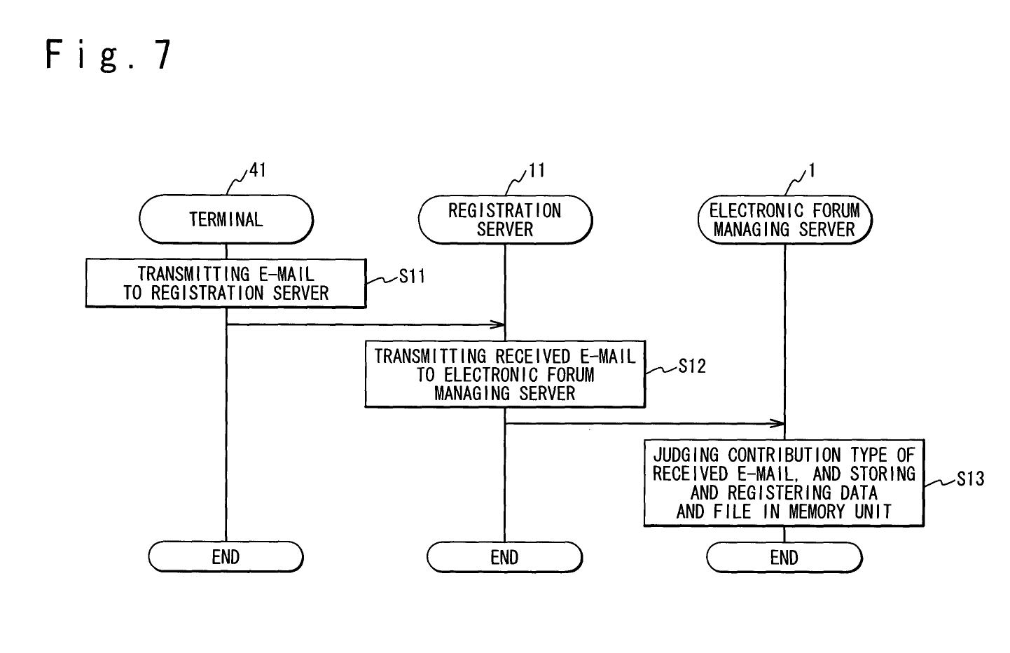

FIG. 7 is a flowchart showing another example of the process when the member in the e-forum submits the data by using the e-mail. FIG. 7 shows the example of registering the submission data in the electronic forum managing server 1 without distributing the e-mail to the respective members. When indicating the [Non-Publication] library, the member uses this method and carries out the submission.

In accordance with the operation of the member in the e-forum, the terminal 41 defines the e-mail address [biocoml@abc.co.jp] of the registration server 11 as the transmission destination. Then, the terminal 41 transmits the e-mail (step 11). In the step 11, the member designates the library on the subject field of the e-mail in the predetermined format when designating the library, similarly to the step S01. When indicating the [Non-Publication] library, it is enough to write the [<<LIB NP Non-Publication>>] after the title. When the terminal 41 transmits the e-mail to the registration server 11, it is allowable to indicate a different library.

The control unit 12 of the registration server 11 receives this e-mail without the intervention of the Mailing list server 31. Then, the control unit 12 transmits the e-mail to the electronic forum managing server 1 (Step S12). The control unit 12 uses the e-mail address of the member transmitting the e-mail at the step S21 as the transmission source, and transmits it in its original state without adding any change to the portion where the [<<LIB NP Library Name>>] on the subject field is noted.

The control unit 2 of the electronic forum managing server 1 refers to the subject field and thereby judges the submission type, when receiving the e-mail from the registration server 11. Then, in accordance with the submission data, it stores the text data and the attached file of the e-mail as the submission data 6 in the memory unit 4 (Step S13).

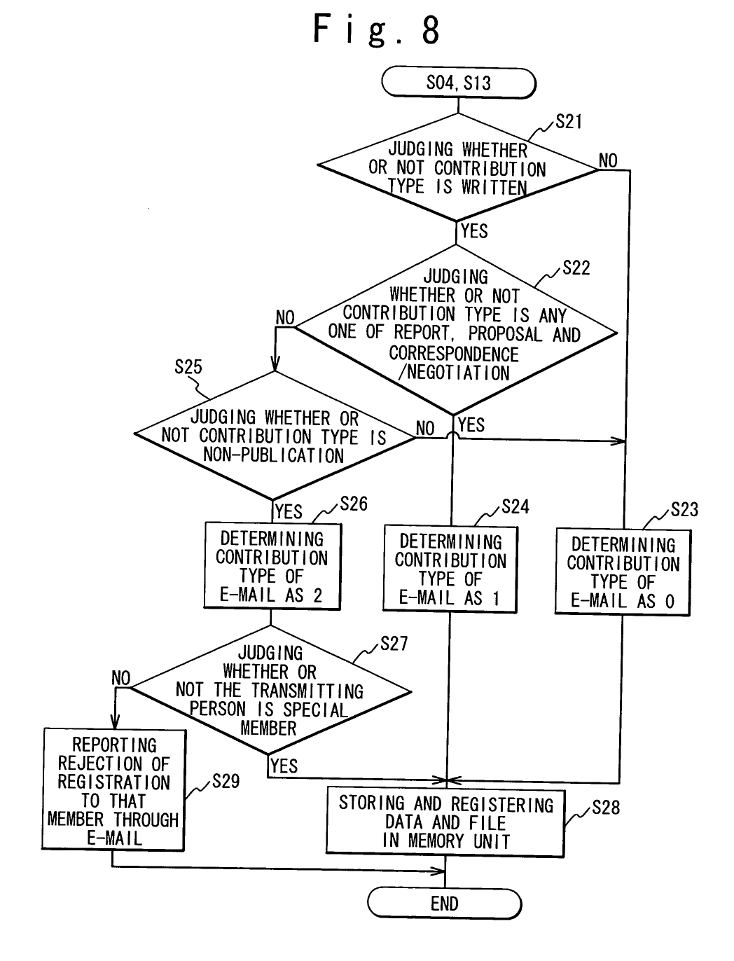

FIG. 8 is a flowchart showing an example of the process of the step 04 and the step S13.

In the step S04 or the step S13, the control unit 2 refers to the subject field to judge whether or not the submission type is written (step S21).

When the submission type is not written in the subject field (“No” in the step S21), the control unit 2 judges and determines the submission type of the e-mail as 0 (step S23).

When the submission type is written in the subject field (“Yes” in the step S21), the control unit 2 judges whether or not the submission type is any one of [Report], [Proposal] and [Correspondence/Negotiation] (step S22).

When the submission type is any one of [Report], [Proposal] and [Correspondence/Negotiation] (“Yes” in the step S22), the control unit 2 judges and determines the submission type of the e-mail as 1 (step S24).

When the submission type is not any one of [Report], [Proposal] and [Correspondence/Negotiation] (“No” in the step S22), the control unit 2 judges whether or not the submission type is [Non-Publication] (step S25).

When the submission type is not [Non-Publication] (“No” in the step S25), the control unit 2 judges and determines the submission type of the e-mail as 0 (step S23).

When the submission type is [Non-Publication] (“Yes” in the step S25), the control unit 2 judges and determines the submission type of the e-mail as 2 (step S26).

The control unit 2 judges whether or not the transmitting person is the special member based on the e-mail address of the transmitting person and the user data 8 (step S27).

When the transmitting person is not the special member (“No” in the step S27), the control unit 2 reports the rejection of the registration to that member through the e-mail (step S29).

Then, the control unit 2 stores the text data and the attached file in the memory unit 4 and then registers the respective store region data in the management database 7 (Step S28). Here, when the submission type is 0, the library data is registered as [Nothing]. When the submission type is 1, the library data is registered as corresponding one of [Report], [Proposal] and [Correspondence/Negotiation]. When the submission type is 2, the library data is registered as [Non-Publication].

Here, the case in which the member indicates the [Non-Publication] and transmits the e-mail is described. However, it is allowable to transmit the e-mail to the [biocoml@abc.co.jp] without indicating the [Non-Publication]. In this case, the e-mail is not distributed to other members.

Still another operation of the embodiment of a submission data managing system according to the present invention will be described below.

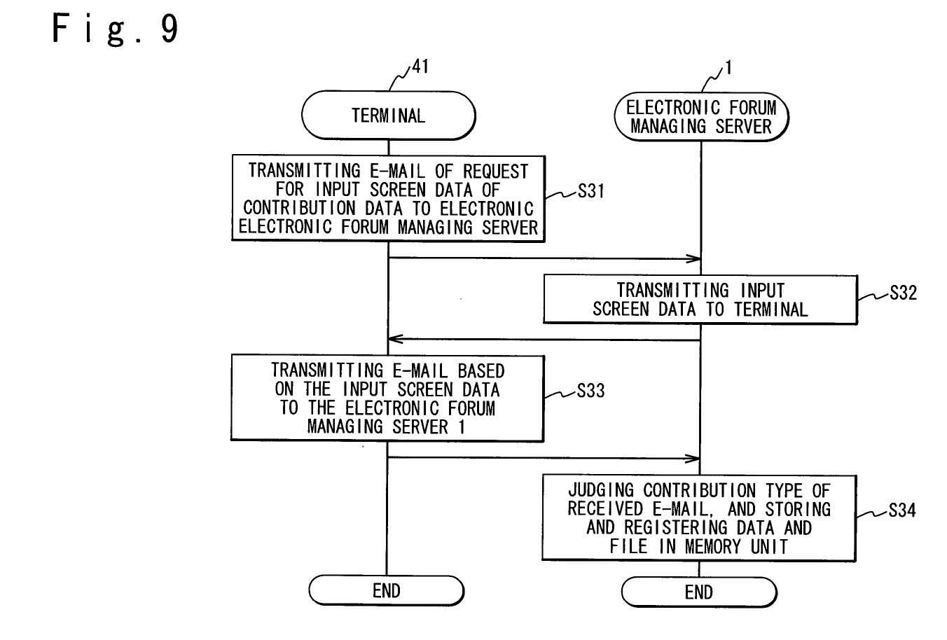

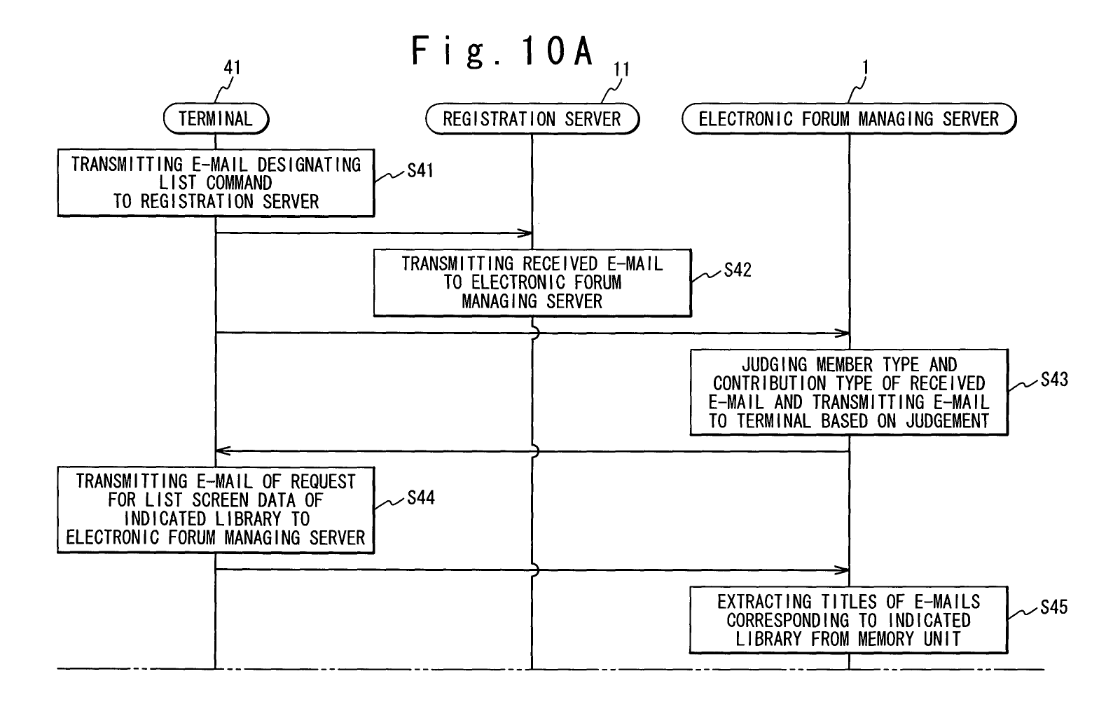

FIG. 9 is a flowchart showing another example of the process in which the electronic forum managing server 1 receive the registration of the data directly from the terminal 41. The electronic forum managing server 1 may receive the registration of the data directly from the terminal 41.

The terminal 41 transmits the e-mail, which is a request for an input screen data of the submission data, to the electronic forum managing server 1 (step S31). The electronic forum managing server 1 transmits the input screen data to the terminal 41, in response to the request from the terminal 41 (step S32). The input columns for the title and the main sentence, the indication column for the attached file and a transmission button are installed on the input screen. The terminal 41 displays thereon this input screen and then urges the member to input. The member inputs the title, the main sentence and the like to the input screen. When indicating a library, it is enough to indicate the library in a predetermined format on the input column for the title. Also, if a file is attached, the attached file is indicated on the input screen. The member inputs the submission data and then mouth-clicks the transmission button. So, the terminal 41 attaches the input title and the file indicated to the main sentence, and then transmits an e-mail with them (based on the input screen data) to the electronic forum managing server 1 (step S33).

At this time, the terminal 41 may transmit, for example, the main sentence, the title, the attached file and the like as the e-mail or may transmit them as a manner other than the e-mail. Incidentally, if they are transmitted as the manner other than the e-mail, an e-mail input column for a transmitting person is installed on the input screen, and even the data of the e-mail address of the transmitting person is designed to be transmitted to the electronic forum managing server 1.

The electronic forum managing server 1, receiving the data inputted to the input screen, refers to the title and thereby judges a submission type. Then, it stores the title and the main sentence as the text data in the memory unit 4, based on the submission type. Also, it stores the attached file in the memory unit 4. The judgment of the submission type and the storing of the data in the memory unit 4 may be done similarly to the step S04 or S13, as shown in FIG. 8.

Next, yet still another operation of the embodiment of a submission data managing system according to the present invention will be described below.

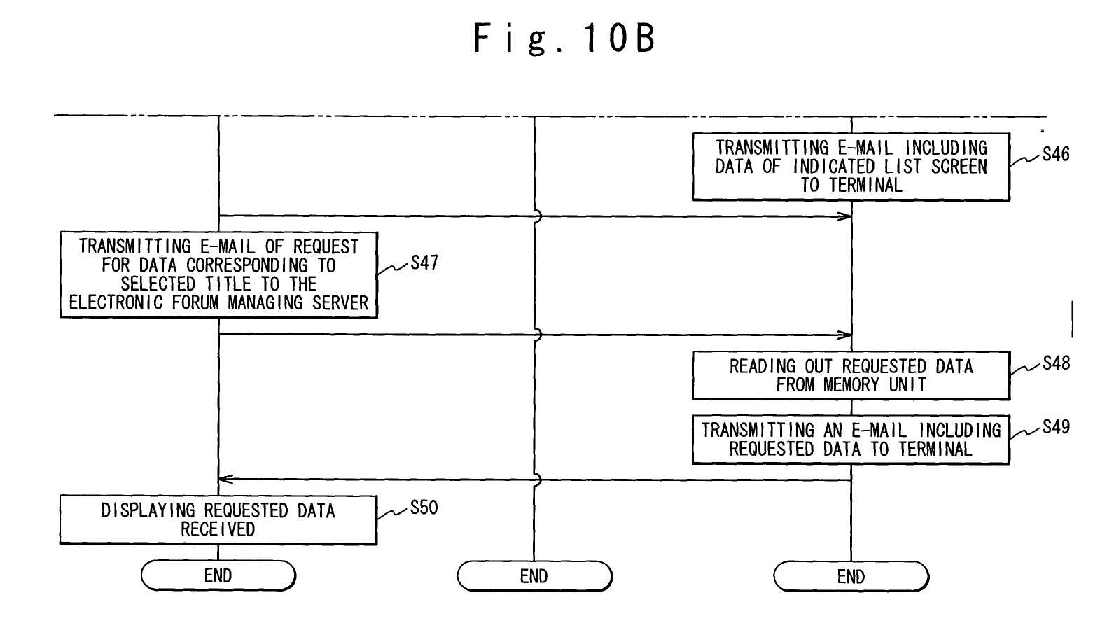

FIGS. 10A and 10B are flowcharts showing another example of the process in which each member reads the submission data stored in the electronic forum managing server 1.

The terminal 41 transmits the e-mail designating the LIST command, in accordance with the operation of the member in the e-forum (step S41). The transmission destination of this e-mail may be the e-mail address [biocoml@abc.co.jp] assigned to the registration server 11. The LIST command is designated by writing a predetermined string to the subject field. For example, [<<CMD LIST>>] is written.

The registration server 11, when receiving the e-mail to the [biocoml@abc.co.jp], transmits the received e-mail to the electronic forum managing server 1, similarly to the case of the step S03 (step S42) The registration server 11, when transferring the e-mail to the electronic forum managing server 1, defines the e-mail address of the member transmitting the e-mail as the transmission source.

The control unit 2 of the electronic forum managing server 1, when receiving the e-mail from the registration server 11, refers to the subject field and thereby judges the submission type. When the [<<CMD LIST>>] is noted on the subject field, it judges as a submission type 3. When judging as the submission type 3, the control unit 2 judges whether the transmitting person of the LIST command is the special member or the common member, based on the e-mail address of the transmission source and the user data 8. Then, the control unit 2 makes the e-mail in which the link to each list screen is set (refer to FIG. 5), based on the type of the member. After that, the control unit 2 returns the e-mail to the member (step S43) However, when the transmitting person of the LIST command is the common member, it returns the e-mail including only the link setting portions 101 to 103. Although the notation of the [Non-Publication] may be allowable, the link between that notation and the screen exemplified in FIG. 2E is not set. On the other hand, the e-mail including the link setting portions 101 to 104 is returned to the special member.

Also, when the e-mail address of the transmitting person is not included in the user data 8, the control unit 2 judges that transmitting person as a third party and does not reply to the LIST command.

The member receiving the e-mail exemplified in FIG. 5 mouth-clicks the link setting portion in the desired library and then indicates the library. The terminal 41 transmits the e-mail, which is a request for the list screen data of the indicated library, to the electronic forum managing server 1 (step S44). However, in the e-mail transmitted to the common member, the link is not set for the indication of the [Non-Publication]. Thus, the common member can not request the list screen of the [Non-Publication] library.

The control unit 2 of the electronic forum managing server 1 refers to the management database 7 and extracts the titles of the e-mails corresponding to the indicated library from the memory unit 4 (step S45). For example, when the [Report] library is indicated, the control unit 2 uses the store region data (6-2) of the text data corresponding to the [Report] and extracts the titles of the e-mails.

The control unit 2 transmits e-mail including the data of the indicated list screen to the terminal 41 (step S46).

Here, the case in which the control unit 2 transmits the data of the list screen exemplified in FIG. 2B based on the request from the terminal 41 will be exemplified below.

The terminal 41 receives and displays the data of the list screen in which the respective extracted titles are included and the link to the text data is set for each title in the display. The terminal 41 urges the member to select the title.

The member mouth-clicks the title of the data desired to be read, from the respective titles displayed on the list screen. The link to the text data is set for this title. Thus, the terminal 41 transmits the e-mail, which is a request of the text data corresponding to the mouth-clicked title, to the electronic forum managing server 1 (step S47). For example, in the terminal 41, the [Research Result Report No.1] is mouth-clicked on the list screen shown in FIG. 2B. In this case, the terminal 41 requests the text data of the [Research Result Report No.1].

The control unit 2 of the electronic forum managing server 1 reads out the requested text data from the memory unit 4 (step S48). Then, the control unit 2 transmits an e-mail including the screen data representative of this text data to the terminal 41 (step S49).

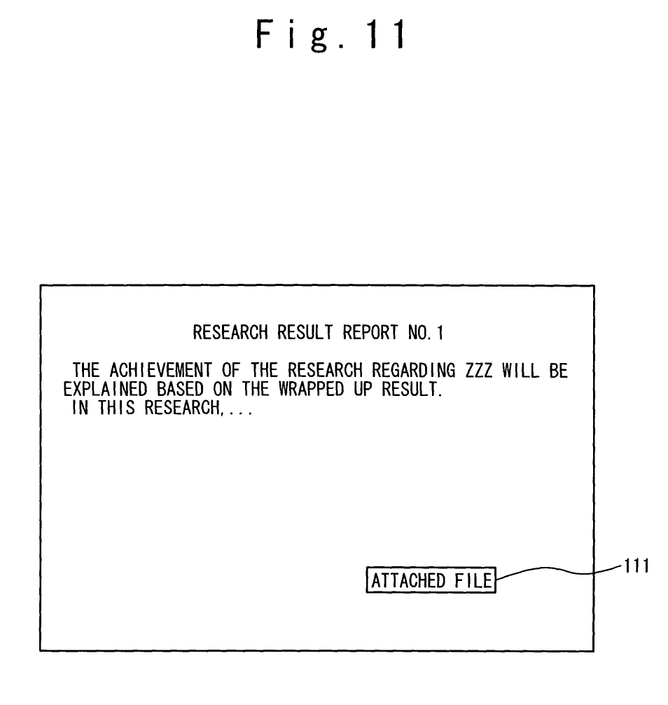

The terminal 41 receives the screen data and then displays thereon the screen exemplified in FIG. 11 (step S50). FIG. 11 is a view showing an example of a display screen of the text data. Here, in the display screen, the text data of [Research Result Report No.1] is displayed. When there is an attached file other than the text data, a link setting portion 111 to the attached file is included in the screen data by the control unit 2. When the member mouth-clicks the link setting portion 111 to the attached file, the terminal 41 requests the attached file from the electronic forum managing server 1. The control unit 2 reads out the indicated attached file from the memory unit 4 and then transmits the attached file to the terminal 41. The terminal 41 displays thereon the attached file. This process regarding the request for the attached file is carried out similar to the steps S47 to S50.

The terminal 41 can store the URL of the once displayed screen. This function is attained by the browser. The terminal 41 stores the URL of the displayed screen, when receiving the instruction of the storing of the URL from the member. When the stored URL is indicated, the terminal 41 again requests the screen of the URL from the electronic forum managing server 1. Thus, when the list screen of each library is read a plurality of times, it is enough to store the URL of the list screen in the terminal 41. The member, when indicating the URL stored in the terminal 41, can again read the desired list screen immediately without re-transmitting the LIST command.

Also, the member itself can again request the same screen from the electronic forum managing server 1 from the terminal 41 by memorizing the URL of the once displayed screen and then inputting the URL to the terminal 41.

Also, the member may select the respective titles on the entire screen (FIG. 2A) without selecting the respective titles on the list screens of the libraries. When the URL of the entire screen is inputted, the terminal 41 requests the entire screen from the electronic forum managing server 1. The control unit 2 of the electronic forum managing server 1 refers to the management database 7 and extracts the titles of the respective e-mails except the [Non-Publication] library from the memory unit 4. Concretely, the titles are extracted by using the store region data (6-2) of the text data corresponding to the [Report], the [Proposal], the [Correspondence/Negotiation] and the [Nothing]. The control unit 2 transmits to the terminal 41 the data of the entire screen in which the respective extracted titles are included and the link to the text data is set for the respective titles. The terminal 41 receives this data and displays the entire screen exemplified in FIG. 2A. The operation when the title is mouth-clicked on the entire screen is similar to the steps S41 to S50 when the title is mouth-clicked on the list screen.

The manager of the e-forum reports the notice (care items) with regard to the transmission destination of the e-mail to the respective members in advance. For example, when transmitting the e-mail indicative of the [Non-Publication] library or the e-mail designative of the LIST command, it reports the transmission to the e-mail address [biocoml@abc.co.jp] assigned to the registration server 11 in advance. Also, The manager reports the URL of the entire screen to the respective members in advance and thereby allows the respective members to access the entire screen. Also, the manager reports the notice (care items) that the URLs of the respective screens, such as the entire screen, the list screens and the like, should not be taught to the third party, to the members in advance. The notice (care items) that the member does not reveal the URLs to the third party who does not belong to the e-forum protects the submission data from being leaked.

According to the present invention, each of the members can store the submission data while correlating with the library indicated at the time of the submission and then display the list screen for each library. Thus, without any necessity that the manager reads the respective data and selects the important data, each of the members can check the list of the important data collected for each library. This leads to the reduction in the burden of the manager.

The third party that does not belong to the e-forum can not receive the e-mail exemplified in FIG. 11 even though transmitting the LIST command. Moreover, the respective members never teach the URLs of the respective screens to the third party. Thus, the third party can not read the submission data. Consequently, even though the authentication through the user ID and the password is not done, the leakage of the submission data can be protected so that each of the members need not input the user ID and the password each time each of the members reads the submission data. Also, when the URL of the once read screen is stored in the terminal 41, the burden of each of the members is reduced since the re-display of that screen can be immediately done.

Also, the particular data (the data of the [Non-Publication] library) can be managed in such a way that only a part of the members can read it.

In this embodiment, the case in which the four kinds of the libraries are used is described. However, the number of the libraries is not limited to the four kinds. Also, the names of the libraries are not limited to the [Report], the [Proposal], the [Correspondence/Negotiation] and the [Non-Publication].

Also, the submission data managing system in the present invention may manage the submission data in a plurality of e-forums. For example, a submission data in a different e-forum may be managed in addition to the e-forum for the biotechnology relation business. In this case, an e-mail address for a mailing list is prepared for each e-forum. The Mailing list server 31 may manage the e-mail address data 36 for each e-forum. Also, an e-mail address for each e-forum is assigned to the registration server 11 and the electronic forum managing server 1. The registration server 11 and the electronic forum managing server 1, when receiving the e-mail, may check the e-mail address serving as a destination and thereby judge an e-forum to which the submission data belongs.

FIG. 1 shows the case in which the submission data managing system includes the electronic forum managing server 1, the registration server 11 and the mailing list server 31. This may be designed in such a way that the e-mail transmitted by the member is directly transferred from the mailing list server 31 to the electronic forum managing server 1. The electronic forum managing server land the registration server 11 may be configured as one unit. The electronic forum managing server 1 and the mailing list server 31 may be configured as one unit. The electronic forum managing server 1, the registration server 11 and the mailing list server 31 may be configured as one unit.

Also, there may be a case that each of the members erroneously indicates the library. This may be designed such that the manager of the e-forum can check the content of the submission data and thereby change the library if there is an error in the indication of the library.

An embodiment in which the manager changes the library of the submission data is explained. In this case, even a manager terminal (one of terminals 41) is connected to the communication network 51. For each certain period (for example, for each week), the control unit 2 of the electronic forum managing server 1 transmits the list data of the titles of the respective e-mails received in that period as the e-mail to the manager terminal. A link to that main sentence is set for each of the titles. Also, the data of the library indicated together with that title is displayed.

When the title is mouth-clicked, the manager terminal requests the screen exemplified in FIG. 11 from the electronic forum managing server 1. The electronic forum managing server 1 transmits the display screen data of the submission data in response to the request from the manager terminal (the process is similar to the step S47 to S50). The manager checks this submission data and judges whether or not the indication of the library is correct. If it is not correct, the manager terminal instructs the electronic forum managing server 1 to change the library. The electronic forum managing server 1 updates the data of the library of the management database 7, in response to the instruction from the manager terminal. Also, the manager instructs to delete the submission data from the manager terminal. In accordance with that instruction, the electronic forum managing server 1 may delete the submission data and then update the management database 7. The frequency at which each member erroneously indicates the library is small. Thus, even though the manager changes the indication of the library, the burden of the manager is reduced over the conventional burden. In this embodiment, the newest data reporting unit is attained by the network interface unit 3 and the control unit 2 of the electronic forum managing server 1.

Also, in the above-mentioned respective embodiments, the case in which the respective members are classified into the common member and the special member is explained. However, the kinds of the members are not limited to those two kinds. For example, a kind of [special treatment member] may be set in addition to those two kinds. The special treatment member is the member who can read all of the libraries although the e-mail distributed as the mailing list is unnecessary. When the kind of the [special treatment member] is set, the e-mail address of the special treatment member is not included in the e-mail address data 36 of the mailing list server 31. Then, the fact that the member is the special treatment member is defined in the user data 8 of the electronic forum managing server 1. The control unit 2, when receiving the e-mail indicative of the [Non-Publication], admits the registration of the submission data if the transmitting person of the e-mail is the special member or the special treatment member. Also, when receiving the e-mail designative of the LIST command, it transmits the e-mail exemplified in FIG. 5 if the transmitting person of the e-mail is the special member or the special treatment member.

In the above-mentioned respective embodiments, the members are classified into the persons who can read the [Non-Publication] library and the persons who can not read. The range of the data that can be read on the basis of a right may be divided into many stages. That is, the various rights may be defined such as a right under which only one library can be read, a right under which only two libraries can be read, a right under which three rights can be read, and the like. An embodiment in this case will be described below.

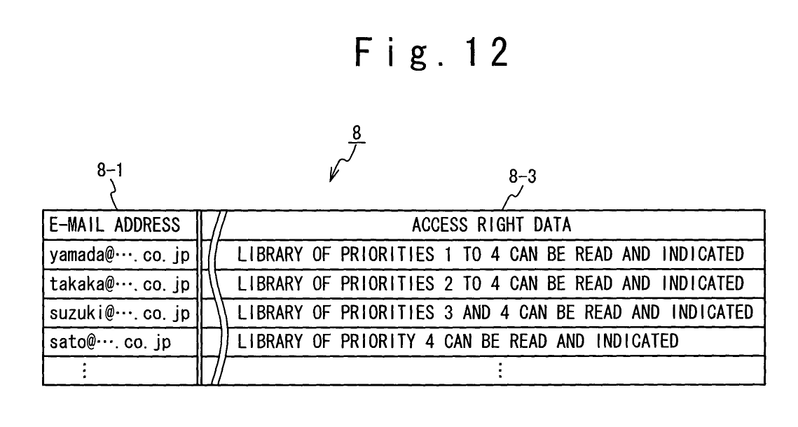

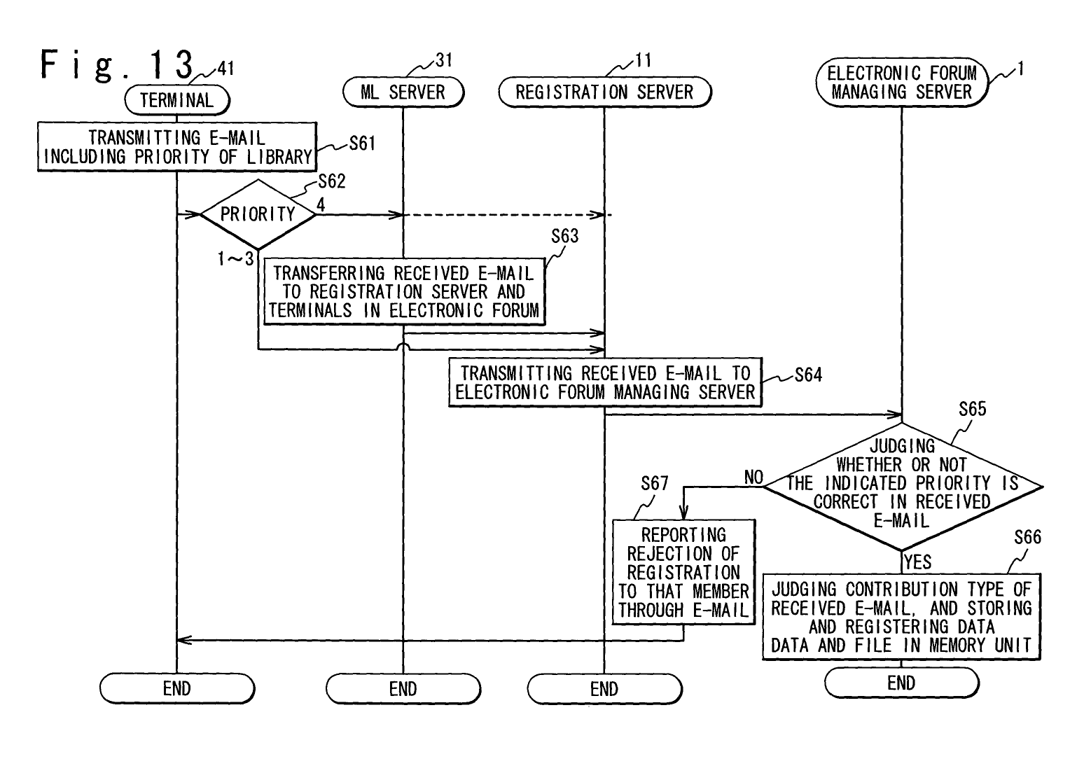

In this embodiment, a priority is defined for each library. Here, a case is exemplified in which libraries of four kinds of priorities 1 to 4 are used. FIG. 12 is a view showing the example of the user data 8 in this embodiment. The user data 8 includes the e-mail address 8-1 and the access right data 8-3. The e-mail address 8-1 corresponding to the each member is related to the access right data 8-3 of each member. The rights of the respective members are classified into the four kinds of the rights. The first one is a right under which only a library of the priority 4 can be read and indicated. The second one is a right under which libraries of the priorities 3 and 4 can be read and indicated. The third one is a right under which libraries of the priorities 2 to 4 can be read and indicated. The last one is a right under which libraries of the priorities 1 to 4 can be read and indicated. Each of the members, when applying a member license of the e-forum, indicates the right based on its post. For example, a common employee applies the right of the first one. A subsection chief applies the right of the second one. A section chief applies the right of the third one. And, a department chief applies the right of the last one.

The electronic forum managing server 1 relates the access right applied to the e-mail address of an applicant, and then adds to the user data 8. The electronic forum managing server 1 receives the application, for example, through the communication network 51 from the terminal 41.

Also, the electronic forum managing server 1, if receiving the application of the license of the member in the e-forum, transmits the e-mail address of that member to the mailing list server 31, and then instructs the addition to the e-mail address data 36.

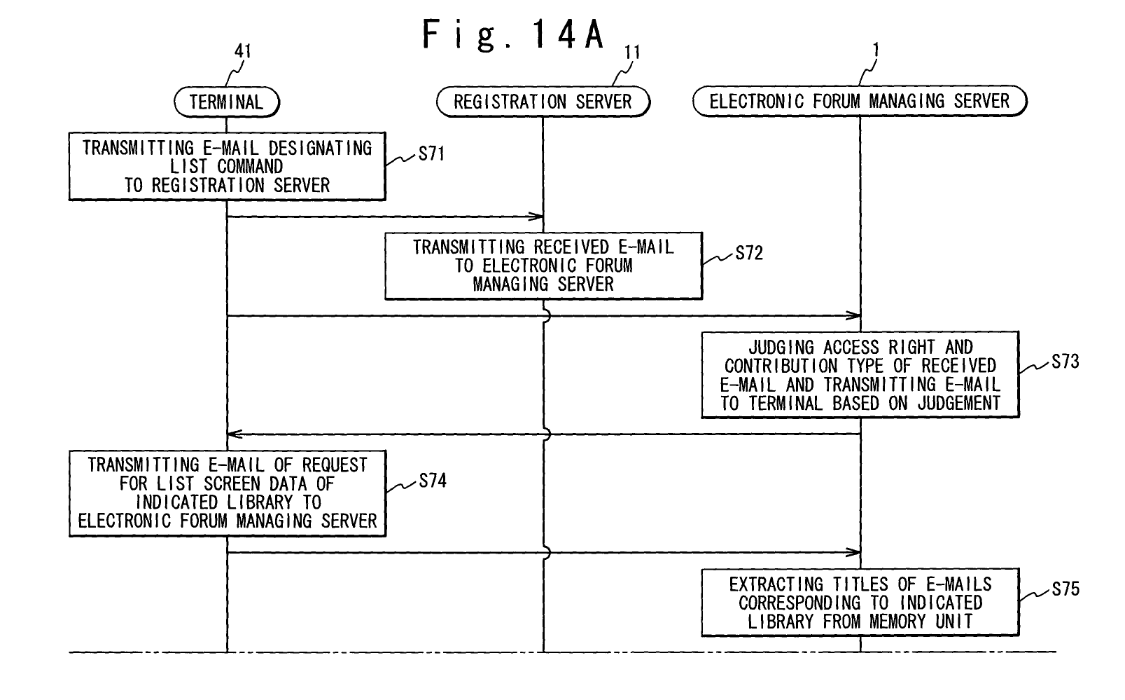

The operation of the embodiment of a submission data managing system according to the present invention will be described FIG. 13 is a flowchart showing another example of the process when each member carries out the submission through the e-mail.

The terminal 41 transmits the e-mail including the priority of the library indicated by each members (step S61). It is enough that the member only writes the priority to the subject field in a predetermined format. Here, the common employee can indicate only the priority 4. The subsection chief can indicate the priority 3 or 4. The section chief can indicate any of the priorities 2 to 4. The department chief can indicate any of the priorities 1 to 4. Each of the members indicates the priority and then transmits the e-mail.

However, each member, if indicating the priorities 1 to 3, transmits the e-mail to the registration server 11. Each member, if indicating the priority 4, may transmit to any of the Mailing list server 31 and the registration server 11.

When transmitting the e-mail, the terminal 41 judges the priority in the e-mail. Then, it sends the e-mail to the registration server 11 when the priority is any one of 1, 2 and 3, to any one of the mailing list server 31 and the registration server 11 when the priority is 4 (step S62). In the later case, the member indicates in the e-mail.

The operations of the mailing list server 31 in the step S63 and the registration server 11 in the step S64 are similar to those of the mailing list server 31 in the step S02 and the registration server 11 in the steps S03, respectively.

The control unit 2 of the electronic forum managing server 1, when receiving the e-mail from the registration server 11, judges whether or not the indicated priority is correct (step S65). That is, it refers to the e-mail address of the transmission source and the user data 8 and thereby judges whether or not the transmitting person indicates the priority based on the access right (8-3).

When the correct priority is indicated (“Yes” in the step S65), similarly to the step S04, the control unit 2 stores the text data and the attached file of the e-mail as the submission data 6 in the memory unit 4. Then, it registers the respective store region data in the management database 7 (step S66). The indicated priority is also registered as the library data.

When the correct priority is not indicated (“No” in the step S65), the control unit 2 reports the rejection of the registration to that member through the e-mail (step S67).

Next, the other operation of the embodiment of a submission data managing system according to the present invention will be described below.

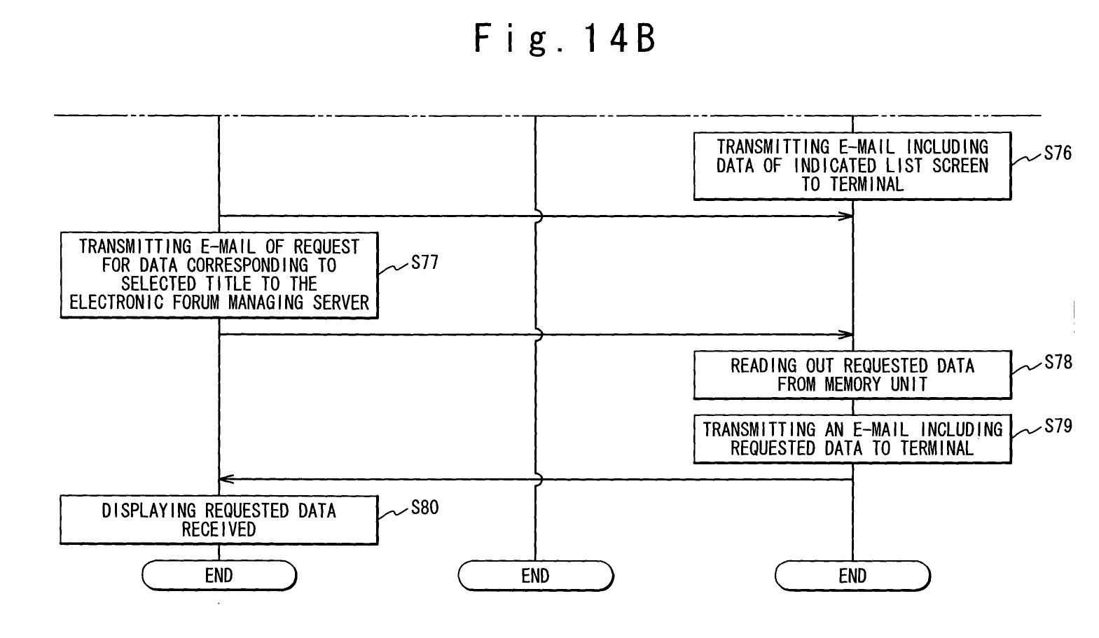

FIGS. 14A and 14B are flowcharts showing another example of the process in which the member selects the desired data from the list screen of each of the libraries based on the access right.

The operations in the steps 71 to S72 are similar to those in the steps S41 to S42.

The control unit 2 of the electronic forum managing server 1, when receiving the e-mail designative of the LIST command from the terminal 41, refers to the user data 8 and checks the access right of the transmitting person. Then, it transmits to the terminal 41 the e-mail in which the link to the list screen of the library is set on the basis of the access right (step S73).

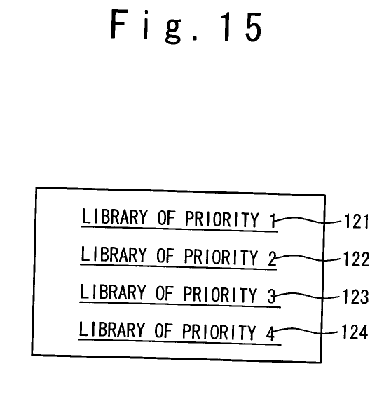

FIG. 15 is a view showing an example of an e-mail to be transmitted to the member having the right under which the libraries of the priorities 1 to 4 can be read. The links to the list screens of the libraries of the priorities 1 to 4 are set for link setting portions 121 to 124, respectively. The member receiving the e-mail exemplified in FIG. 15 mouth-clicks the link setting portions 121 to 124 to obtain the list screens and to select the desired data.

Here, the link setting portion 121 is not set for the e-mail to the member having the right under which the libraries of the priorities 2 to 4 can be read. Similarly, the link setting portions 121, 122 are not set for the e-mail to the member having the right under which the libraries of the priorities 3, 4 can be read. Also, the link setting portions 121 to 123 are not set for the e-mail to the member having the right under which only the library of the priority 4 can be read.

When the link setting portions 121 to 124 are mouth-clicked, the terminal 41 transmits the requests for the list screen of the indicated library to the electronic forum managing server 1 (step S74).

The control unit 2 refers to the management database 7 and then extracts the title of the e-mail corresponding to the indicated library from the memory unit 4 (step S75). For example, if the library of the priority 1 is indicated, it uses the store region data of the text data corresponding to the [Priority 1] and extracts the title. The control unit 2 transmits to the terminal 41 an e-mail including the data of the screen (the data of the list screen) in which the respective extracted titles are included and the links to the text data are set for the respective titles (step S76).

The terminal 41 receives and indicates the data of the list screen to the member, and then urges to select the title.

The member mouth-clicks the title of the data desired to be read, from the respective titles displayed on the list screen. The link to the text data is set for this title. Thus, the terminal 41 transmits the e-mail, which is a request of the text data corresponding to the mouth-clicked title, to the electronic forum managing server 1 (step S77).

The operations in the steps 78 to S80 are similar to those in the steps S48 to S50. The steps 71 to S72 are similar to the steps S41 to S42.

Consequently, the range of the data that can be read on the basis of the right can be divided into many stages

In the above-mentioned respective embodiments, the case in which the library is indicated in the subject field is explained. However, the library may be indicated in an input column other than the subject field. For example, the member may indicate the library by using a first line of the main sentence in the e-mail, and the electronic forum managing server 1 may judge the indicated library on the basis of the description on the first line of the main sentence. Also, the member may indicate the library by using a header of the e-mail, and the electronic forum managing server 1 may refer to the header to thereby judge the indicated library.

According to the submission data managing system of the present invention, this includes: the submission data storing unit for classifying the received submission data in accordance with the class data received together with the submission data and storing in the memory; the list screen displaying unit for displaying the list screen indicative of the list of the received submission data on the terminal for each class; and the submission data displaying unit for transmitting the submission data selected from the list to the terminal. Thus, the e-mail transmitted by the member is classified into the class indicated by the member and stored. The manager need not classify the data while checking the e-mails, one by one. Hence, the burden of the manager is reduced.

What is claimed is:

1. A submission data managing system comprising:
a submission data storing unit which stores a submission data and a class data, wherein said submission data is submitted by any one of members in an electronic forum, and said class data indicates any one of classes to which said submission data belongs;
a list screen supplying unit which outputs a list screen data to a terminal of said one of members, in response to a request for said list screen data from said terminal, wherein said list screen data indicates a list of said submission data in said one of classes stored in said submission data storing unit; and
a submission data supplying unit which outputs said submission data to said terminal, in response to a request for said submission data selected from said list from said terminal,
wherein said class data is supplied with said submission data, said submission data storing unit relates said submission data to said class data while storing said submission data and said class data.

2. The submission data managing system according to claim 1, wherein said submission data storing unit receives said submission data with said class data through an electronic mail.

3. The submission data managing system according to claim 2, wherein said submission data storing unit judges said class data by referring to a data in a subject field of said electronic mail.

4. The submission data managing system according to claim 1, wherein said list screen supplying unit generates and outputs an input screen data indicating an input screen displayed on said terminal which urges said member to input said submission data and said class data.

5. The submission data managing system according to claim 1, wherein said list screen data for each one of classes is identified by URL (Uniform Resource Locator), and
said list screen supplying unit outputs said list screen data corresponding to said URL, in response to a request for said list screen data by using said URL from said terminal.

6. The submission data managing system according to claim 1, wherein said list screen supplying unit outputs a list screen link data to said terminal, in response to a request for said list screen link from said terminal, said list screen link data includes link to said list screen data.

7. The submission data managing system according to claim 6, further comprising:
a user data storing unit which stores a user data which relates said one of members to one of rights, wherein said one of rights is a right to access submission data in a predetermined class,
wherein said list screen supplying unit outputs said list screen link data to said terminal, said list screen link data includes link to said list screen data corresponding to said predetermined class, in response to a request for said list screen link data from said terminal.

8. The submission data managing system according to claim 7, wherein said predetermined class is a non-publication class, and
said list screen supplying unit outputs said list screen link data in which link to said list screen data including said non-publication class are set, in response to a request for said list screen link data from said terminal having said one of rights.

9. The submission data managing system according to claim 8, wherein said list screen supplying unit outputs said list screen link data in which link to said list screen data excluding said non-publication class are set, in response to a request for said list screen link data from said terminal not having said one of rights.

10. The submission data managing system according to claim 6, further comprising:
a user data storing unit which stores a user data which relates said one of members to one of rights, wherein said one of rights is a right to access submission data in a predetermined class,
wherein said submission data storing unit relates said submission data to a priority data which is predetermined based on said one of classes, while storing said submission data, and
said list screen supplying unit outputs said list screen link data to said terminal, said list screen link data includes link to said list screen data corresponding to said priority data, in response to a request for said list screen link data from said terminal.

11. The submission data managing system according to claim 1, further comprising:
a latest data reporting unit which sends said list of said submission data received for each certain period, every said certain period to a manager terminal,
wherein said submission data supplying unit outputs said submission data to said manager terminal, in response to a request for said submission data received for each certain period from said manager terminal.

12. A submission data managing method, comprising:
(a) storing a submission data and a class data, wherein said submission data is submitted by any one of members in an electronic forum, and said class data indicates any one of classes to which said submission data belongs;
(b) outputting a list screen data to a terminal of said one of members, in response to a request for said list screen data from said terminal, wherein said list screen data indicates a list of said submission data in said one of classes stored; and
(c) outputting said submission data to said terminal, in response to a request for said submission data selected from said list from said terminal,
wherein said class data is supplied with said submission data, said submission data is related to said class data while storing said submission data and said class data.

13. The submission data managing method according to claim 12, wherein said step (a) comprising:
(a1) receiving said submission data with said class data through an electronic mail.

14. The submission data managing method according to claim 13, wherein said step (a) further comprising:
(a2) judging said class data by referring to a data in a subject field of said electronic mail.

15. The submission data managing method according to claim 12, wherein said step (b) comprising:
(b1) generating and outputting an input screen data indicating an input screen displayed on said terminal which urges said member to input said submission data and said class data.

16. The submission data managing method according to claim 12, wherein said list screen data for each one of classes is identified by URL (Uniform Resource Locator), and
said step (b) comprising:
(b2) outputting said list screen data corresponding to said URL, in response to a request for said list screen data by using said URL from said terminal.

17. The submission data managing method according to claim 12, wherein said step (b) comprising:
(b3) outputting a list screen link data to said terminal, in response to a request for said list screen link from said terminal, said list screen link data includes link to said list screen data.

18. The submission data managing method according to claim 17, further comprising:
(d) storing a user data which relates said one of members to one of rights, wherein said one of rights is a right to access submission data in a predetermined class,
wherein said step (b3) including:
(b31) outputting said list screen link data to said terminal, said list screen link data includes link to said list screen data corresponding to said predetermined class, in response to a request for said list screen link data from said terminal.

19. The submission data managing method according to claim 17, further comprising:
(e) storing a user data which relates said one of members to one of rights, wherein said one of rights is a right to access submission data in a predetermined class,
wherein said step (a) comprising:
(a3) relating said submission data to a priority data which is predetermined based on said one of classes, while storing said submission data, and
said step (b3) including:
(b32) outputting said list screen link data to said terminal, said list screen link data includes link to said list screen data corresponding to said priority data, in response to a request for said list screen link data from said terminal.

20. The submission data managing method according to claim 12, further comprising:
(f) sending said list of said submission data received for each certain period, every said certain period to a manager terminal,
wherein said step (c) comprising:
(c1) outputting said submission data to said manager terminal, in response to a request for said submission data received for each certain period from said manager terminal.

21. A computer program product embodied on a computer-readable medium and comprising code that, when executed, causes a computer to perform the following:
(a) storing a submission data and a class data, wherein said submission data is submitted by any one of members in an electronic forum, and said class data indicates any one of classes to which said submission data belongs;
(b) outputting a list screen data to a terminal of said one of members, in response to a request for said list screen data from said terminal, wherein said list screen data indicates a list of said submission data in said one of classes stored; and
(c) outputting said submission data to said terminal, in response to a request for said submission data selected from said list from said terminal,
wherein said class data is supplied with said submission data, said submission data is related to said class data while storing said submission data and said class data.

22. The computer program according to claim 21, wherein said step (a) comprising:
(a1) receiving said submission data with said class data through an electronic mail.

23. The computer program according to claim 22, wherein said step (a) further comprising:
(a2) judging said class data by referring to a data in a subject field of said electronic mail.

24. The computer program according to claim 21, wherein said step (b) comprising:
(b1) generating and outputting an input screen data indicating an input screen displayed on said terminal which urges said member to input said submission data and said class data.

25. The computer program according to claim 21, wherein said list screen data for each one of classes is identified by URL (Uniform Resource Locator), and
said step (b) comprising:
(b2) outputting said list screen data corresponding to said URL, in response to a request for said list screen data by using said URL from said terminal.

26. The computer program according to claim 21, wherein said step (b) comprising:
(b3) outputting a list screen link data to said terminal, in response to a request for said list screen link from said terminal, said list screen link data includes link to said list screen data.

27. The computer program according to claim 26, further comprising:
(d) storing a user data which relates said one of members to one of rights, wherein said one of rights is a right to access submission data in a predetermined class,
wherein said step (b3) including:
(b31) outputting said list screen link data to said terminal, said list screen link data includes link to said list screen data corresponding to said predetermined class, in response to a request for said list screen link data from said terminal.

28. The computer program according to claim 26, further comprising:
(e) storing a user data which relates said one of members to one of rights, wherein said one of rights is a right to access submission data in a predetermined class,
wherein said step (a) comprising:
(a3) relating said submission data to a priority data which is predetermined based on said one of classes, while storing said submission data, and
said step (b3) including:
(b32) outputting said list screen link data to said terminal, said list screen link data includes link to said list screen data corresponding to said priority data, in response to a request for said list screen link data from said terminal.

29. The computer program according to claim 21, further comprising:
(f) sending said list of said submission data received for each certain period, every said certain period to a manager terminal,
wherein said step (c) comprising:
(c1) outputting said submission data to said manager terminal, in response to a request for said submission data received for each certain period from said manager terminal.
